(19) United States
(12) Patent Application Publication
(10) Pub. No.: US 2026/0000244 A1
(43) Pub. Date: Jan. 1, 2026

(54) SYSTEMS AND METHODS FOR PROVIDING A TEMPERATURE AND HUMIDITY CONTROLLED FOOD APPARATUS

(71) Applicant: The Vollrath Company, L.L.C., Sheboygan, WI (US)

(72) Inventors: Ian Ecclestone, Oostburg, WI (US); James Kaat, Sheboygan, WI (US); Tammy Blied, Sheboygan, WI (US); Tom VanDerPuy, Sheboygan, WI (US); Peter Roever, West Bend, WI (US); Becky Neils, Sheboygan, WI (US)

(73) Assignee: The Vollrath Company, L.L.C., Sheboygan, WI (US)

(21) Appl. No.: 19/254,870

(22) Filed: Jun. 30, 2025

Related U.S. Application Data
(60) Provisional application No. 63/666,468, filed on Jul. 1, 2024.

(51) Int. Cl. A47J 37/06; A47J 36/24

(52) U.S. Cl. CPC A47J 37/0641; A47J 36/2483

(57) ABSTRACT

A food service system comprising a first chamber and a second chamber. The first chamber includes a first heating element to selectively provide heat to the first chamber to heat a food product, and a first channel to facilitate movement of air within the first chamber. The second chamber includes a second channel in communication with the first channel, the second channel facilitates movement of air within the second chamber. The system includes a first fan coupled with the first channel, where the first fan draws air through the second channel and the first channel, and to an exterior of the first chamber to provide temperature control to the first chamber and the second chamber.

### CROSS-REFERENCE TO RELATED PATENT APPLICATION

This application claims the benefit of and priority to U.S. Provisional Application No. 63/666,468, filed on Jul. 1, 2024, the entire disclosure of which is hereby incorporated by reference herein.

### BACKGROUND

The present disclosure relates generally to a food service system. More specifically, the present disclosure relates to a food service system to maintain food at desired characteristics for a predetermined period of time.

Conventional hot bars or other buffets typically store food in temperature-controlled containers that are heated using overhead heaters and/or shelf heaters. The containers can hold the food products relative to the heaters to help keep the food products warm. However, such containers often include an open or exposed area (e.g., one or more sides) to allow access to the food products. However, such designs limit the amount of time the food products remain at desired temperatures and/or in desired condition (e.g., crunchy, crispy, etc.), which may result in food products that become undesirable to consume (e.g., dry, cold, wet, soggy, etc.). Accordingly, a food service system which addresses such challenges of conventional temperature-controlled containers would be desirable.

### SUMMARY

At least one embodiment relates to a food service system comprising a first chamber having one or more walls. The first chamber may include a first heating element to selectively provide heat to the first chamber to heat a food product, and a first channel extending within the first chamber, the first channel to facilitate movement of air within the first chamber. The food service system further includes a second chamber having one or more walls. The second chamber includes a second channel in communication with the first channel, the second channel extending within the second chamber, wherein the second channel facilitates movement of air within the second chamber. The food service system further includes a first fan coupled with the first channel, where the first fan draws air through the second channel and the first channel, and to an exterior of the first chamber to provide temperature control to the first chamber and the second chamber.

Another embodiment relates to a food service system for a first food product and a second food product. The food service system may include a housing and a first chamber within the housing having one or more walls and a first heating element to selectively provide heat to the first chamber to heat the first food product. The food service system also may include a second chamber within the housing having one or more walls and a second heating element to selectively provide heat to the second chamber to heat the second food product. The food service system may further include a first channel in communication with the first chamber, the second chamber, and an exterior of the housing to facilitate movement of air between the first chamber, the second chamber, and the exterior, and a first fan in communication with the first channel, where the first fan draws air from the first chamber and the second chamber and exhausts it to the exterior to provide temperature and humidity control to the first chamber and the second chamber.

Another embodiment relates to a food service apparatus. The food service apparatus may comprise a first chamber having one or more walls and a first heating element to selectively provide heat to the first chamber to heat a first food product, and a second chamber having one or more walls and a second heating element to selectively provide heat to the second chamber to heat a second food product. The food service apparatus may further include a channel in communication with the first chamber, the second chamber, and an exterior of the first chamber and the second chamber to facilitate movement of air between the first chamber, the second chamber, and the exterior, and a fan in communication with the channel, where the fan draws air from the first chamber and the second chamber and exhausts it to the exterior to provide temperature and humidity control to the first chamber and the second chamber.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front perspective view of a food service system, according to an exemplary embodiment.

FIG. 2 is a front view of a food service system of FIG. 1, according to an exemplary embodiment.

FIG. 3 is a side view of a food service system of FIG. 1, according to an exemplary embodiment.

FIG. 4 is a rear view of a food service system of FIG. 1, according to an exemplary embodiment.

FIG. 5 is a side view of a food service system of FIG. 1, according to an exemplary embodiment.

FIG. 6 is a bottom view of a portion of a chamber of a food service system of FIG. 1, according to an exemplary embodiment.

FIG. 7 is a cross-sectional side view of a heating element of a food service system of FIG. 1, according to an exemplary embodiment.

FIG. 8 is a front perspective view of a food service system of FIG. 1, according to an exemplary embodiment.

FIG. 9 is a top view of a heating element of a food service system of FIG. 1, according to an exemplary embodiment.

FIG. 10 is a front view of a control panel of a food service system of FIG. 1, according to an exemplary embodiment.

FIG. 11 is a rear review of a food service system of FIG. 1, according to an exemplary embodiment.

FIG. 12 is a front perspective view of a portion of a food service system of FIG. 1, according to an exemplary embodiment.

FIG. 13 is a rear perspective view of a portion of a food service system of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

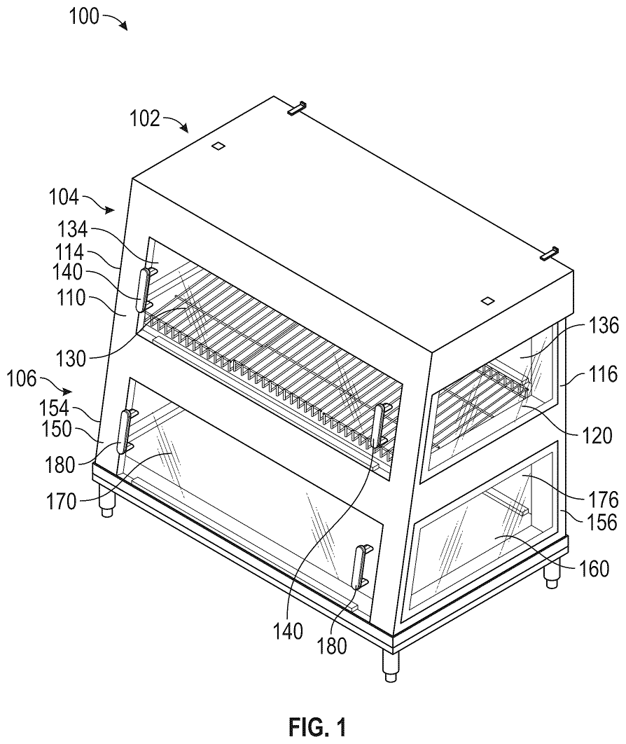

Referring generally to FIGS. 1-13, a food service system 100 is shown according to an exemplary embodiment. The food service system 100 may be configured to maintain various food products at predetermined characteristics for a predetermined period of time, for example, to permit the food products to comply with one or more food product standards or desired serving condition. In an exemplary embodiment, the food service system 100 is configured to maintain a food product (e.g., bone-in chicken, chicken wings, etc.) at a predetermined temperature (e.g., 135 degrees Fahrenheit, etc.) for a predetermined period of time (e.g., 4 hours, etc.), while providing the food product with one or more predetermined characteristics (e.g., a crispy or crunchy exterior, a moist interior, etc.). In an exemplary embodiment, the food service system 100 is also configured to maintain another food product (e.g., chicken tenders, chicken sandwich, etc.) at a predetermined temperature (e.g., 135 degrees Fahrenheit, etc.) for another predetermined period of time (e.g., 2 hours, etc.), while providing the food product with one or more predetermined characteristics (e.g., a moist interior, etc.). In an exemplary embodiment, the food service system 100 is configured to maintain various food products at certain characteristics (e.g., temperature, etc.) for certain periods of time, for example, to comply with various product food standards (e.g., product food safety standards, etc.). It should be understood that while the food service system 100 is described herein as being configured to maintain certain food products at certain characteristics for certain periods of time (e.g., bone-in chicken at 135 degrees Fahrenheit for 4 hours, etc.), it is contemplated that in other embodiments the food service system 100 is configured to maintain other food products, having other characteristics, for other periods of time, for example, to provide the food products with other characteristics and/or to comply with other food product standards.

Referring now to FIG. 1, in an exemplary embodiment the food service system 100 includes a body or housing, shown as a body 102. The body 102 may include a first container, shown as a first chamber 104, and a second container, shown as a second chamber 106. In an exemplary embodiment, the body 102 also includes a control panel 108 having one or more controls, for example, to control a characteristic (e.g., temperature, air flow, humidity, moisture, etc.) of the first chamber 104 and/or the second chamber 106. In an exemplary embodiment, the first chamber 104 and the second chamber 106 are integrated, for example to form connecting chambers. In some embodiments, the first chamber 104 and the second chamber 106 are discrete chambers, for example to form modular chambers.

As described herein, the first chamber 104 may be configured to maintain a first food product at a first set of characteristics for a first period of time, and the second chamber 106 may be configured to maintain a second food product at a second set of characteristics for a second period of time. For example, the first chamber 104 may be configured to maintain bone-in chicken at 135 degrees Fahrenheit for 4 hours, and the second chamber 106 may be configured to maintain chicken tenders, chicken sandwiches, or other food products (e.g., mashed potatoes, fries, etc.) at 135 degrees Fahrenheit for 2 hours. In this regard, the first chamber 104 and/or the second chamber 106 may be configured to be independently controlled (e.g., via the controls of the control panel 108), for example to maintain different characteristics of different food products (e.g., for different periods of time) between the first chamber 104 and the second chamber 106.

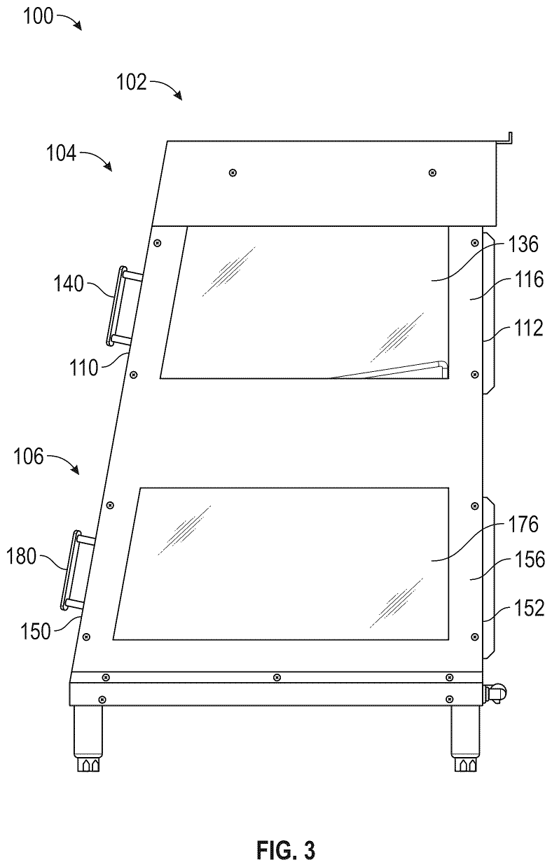

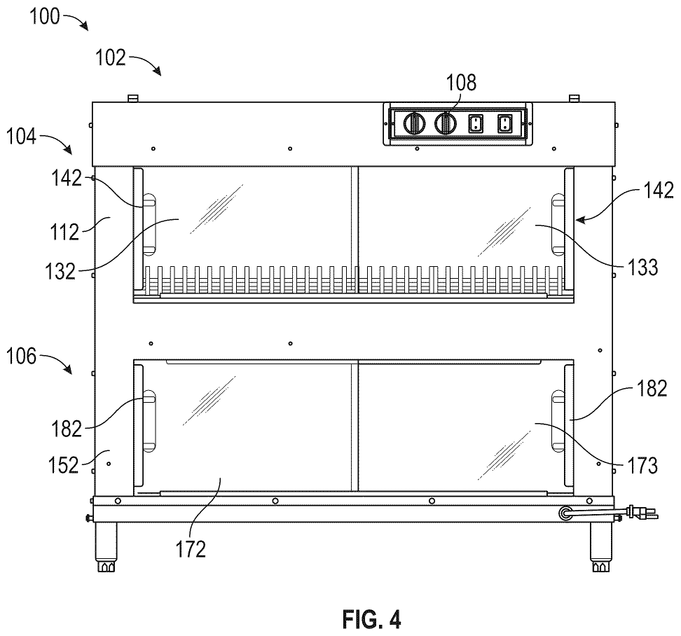

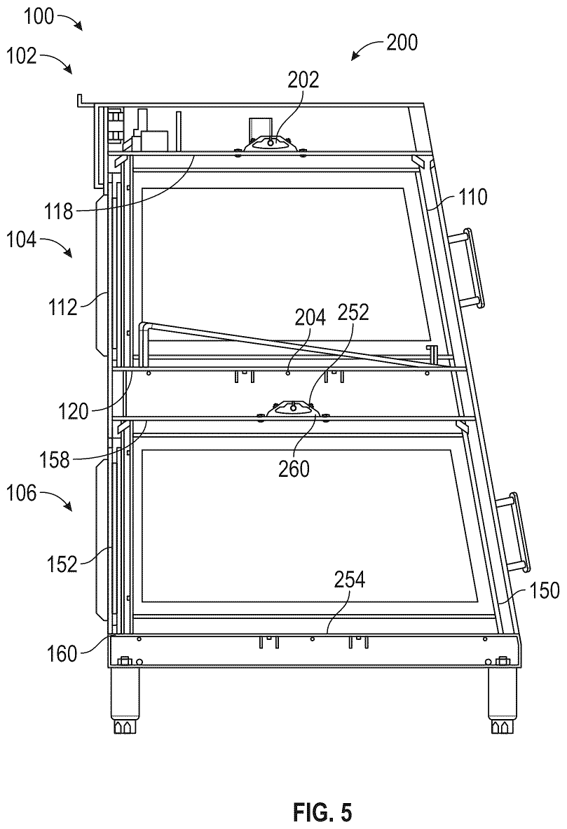

Referring now to FIGS. 1-5, in an exemplary embodiment the first chamber 104 includes a first wall or surface, shown as a front wall 110, a second wall or surface, shown as a rear wall 112 (e.g., as shown in at least FIGS. 3-4), a third wall or surface, shown as a first side wall 114, and a fourth wall or surface, shown as a second side wall 116. Further, the first chamber 104 may include a fifth wall or surface, shown as a top wall 118 (e.g., as shown in at least FIG. 5), and a sixth wall or surface, shown as a bottom wall 120. The walls 110-120 may define the first chamber 104. In an exemplary embodiment, the walls 110-120 define a first cavity 122 within the first chamber 104.

In an exemplary embodiment, the top wall 118 and the bottom wall 120 are substantially parallel (e.g., as shown in at least FIG. 5). In an exemplary embodiment, the front wall 110 is angled relative to the rear wall 112 (e.g., as shown in at least FIG. 5). For example, the top wall 118 and the bottom wall 120 may be substantially parallel, and the front wall 110 may be angled relative to the rear wall 112, such that the first chamber 104 has a trapezoidal cross-sectional shape (e.g., side cross-sectional shape, etc.). In an exemplary embodiment, the walls 110-120 are formed of metal (e.g., stainless steel, sheet metal, etc.) and/or another suitable material.

In an exemplary embodiment, one or more of the walls 110-120 include(s) one or more panels or faces. As shown in FIGS. 1-3, the front wall 110 includes a front panel 130, the first side wall 114 includes a first side panel 134, and the second side wall 116 includes a second side panel 136. As shown in at least FIG. 4, the rear wall 112 includes a first rear panel 132 and a second rear panel 133. The panels 130-136 may be formed of glass or another transparent material, for example, to facilitate visibility into the first chamber 104 (e.g., the first cavity 122). In an exemplary embodiment, one or more of the panels 130-136 are formed of tempered glass. The panels 130-136 may also include a coating on one or more surfaces of the panels (e.g., a low-emissivity coating on an interior surface of panels 130-136, etc.). In an exemplary embodiment, the coatings are configured to facilitate temperature control within the first chamber 104 (e.g., the first cavity 122).

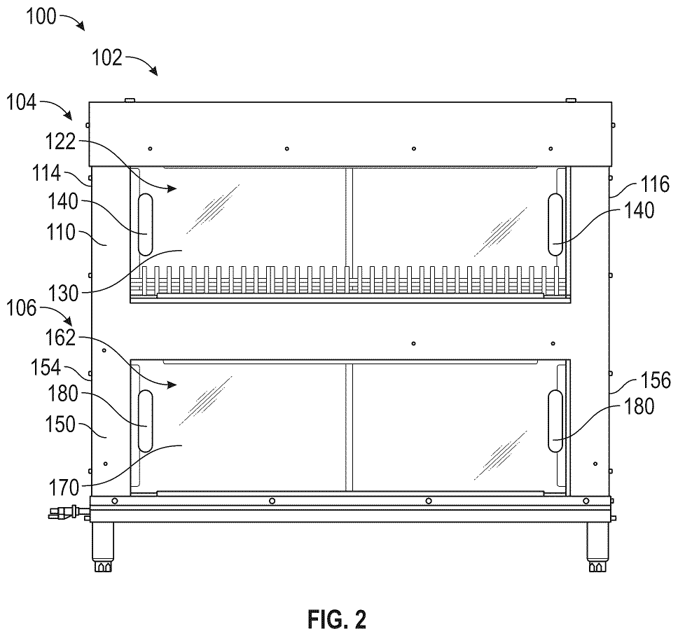

In an exemplary embodiment, one or more of the panels 130-136 include handles, for example, to facilitate gripping and/or engaging the panels 130-136. For example, as shown in FIGS. 1-2 the front panel 130 includes one or more handles 140, for example, to allow a user to engage the front panel 130 and/or manipulate the front panel 130 relative to the front wall 110 (e.g., remove the front panel 130 for cleaning, replacement, etc.). The first rear panel 132 and/or the second rear panel 133 may include one or more handles, shown as handles 142. The handles 142 may also allow a user to engage the first rear panel 132 and/or the second rear panel 133, for example, to move the first rear panel 132 relative to the second rear panel 133 to expose an interior of the first chamber 104 (e.g., the first cavity 122). As such, in an exemplary embodiment one or more of the panels 130-136 are coupled with the walls 110-120 via tracks and/or other movable components (e.g., wheels, rollers, pivot joints, hinges, etc.), such that the panels 130-136 are movable relative to the walls 110-120 and/or other components of the first chamber 104. In some embodiment, the panels 130-136 are coupled with the walls 110-120 via another suitable coupling component (e.g., an adhesive, a bolt or rod, welded or fastened, etc.).

Referring still to FIGS. 1-5, in an exemplary embodiment, the second chamber 106 includes a first wall or surface, shown as a front wall 150, a second wall or surface, shown as a rear wall 152 (e.g., as shown in at least FIGS. 3-4), a third wall or surface, shown as a first side wall 154, and a fourth wall or surface, shown as a second side wall 156. Further, the second chamber 106 may include a fifth wall or surface, shown as a top wall 158 (e.g., as shown in at least FIG. 5), and a sixth wall or surface, shown as a bottom wall 160. The walls 150-160 may define the second chamber 106. In an exemplary embodiment, the walls 150-160 define a second cavity 162 within the second chamber 106.

In an exemplary embodiment, the top wall 158 and the bottom wall 160 are substantially parallel (e.g., as shown in at least FIG. 5). In an exemplary embodiment, the front wall 150 is angled relative to the rear wall 152 (e.g., as shown in at least FIG. 5). For example, the top wall 158 and the bottom wall 160 may be substantially parallel, and the front wall 150 may be angled relative to the rear wall 152, such that the second chamber 106 has a trapezoidal cross-sectional shape (e.g., side cross-sectional shape, etc.). In an exemplary embodiment, the walls 150-160 are formed of metal (e.g., stainless steel, sheet metal, etc.) and/or another suitable material.

In an exemplary embodiment, the first chamber 104 is positioned relative to the second chamber 106 to form the food service system 100 (e.g., the body 102, etc.). For example, the first chamber 104 may be positioned above (e.g., on top of, etc.) the second chamber 106. As such, the bottom wall 120 of the first chamber 104 may be positioned adjacent to (e.g., above, on top of, etc.) the top wall 158 of the second chamber 106. In an exemplary embodiment, the top wall 118 of the first chamber 104 is substantially parallel to the top wall 158 of the second chamber 106. Similarly, the bottom wall 120 of the first chamber 104 may be substantially parallel to the bottom wall 160 of the second chamber 106. In an exemplary embodiment, the front wall 110 of the first chamber 104 and the front wall 150 of the second chamber 106 are substantially parallel. Further, the rear wall 112 of the first chamber 104 and the rear wall 152 of the second chamber 106 may be substantially parallel. In an exemplary embodiment, the walls 110-120 of the first chamber 104 and the walls 150-160 of the second chamber are arranged such that the body 102 has a trapezoidal cross-sectional shape (e.g., side cross-sectional shape, etc.). In other embodiments, the first chamber 104 is otherwise positioned and/or oriented relative to the second chamber 106 (e.g., below, offset from, adjacent or lateral to, etc.), for example, to form the food service system 100 (e.g., the body 102).

In an exemplary embodiment, one or more of the walls 150-160 include(s) one or more panels or faces. As shown in FIGS. 1-3, the front wall 150 includes a front panel 170, the first side wall 154 includes a first side panel 174, and the second side wall 156 includes a second side panel 176. As shown in at least FIG. 4, the rear wall 152 includes a first rear panel 172 and a second rear panel 173. The panels 170-176 may be formed of glass or another transparent material, for example, to facilitate visibility into the second chamber 106 (e.g., the second cavity 162). In an exemplary embodiment, one or more of the panels 170-176 are formed of tempered glass. The panels 170-176 may also include a coating on one or more surfaces of the panels (e.g., a low-emissivity coating on an interior surface of panels 170-176, etc.). In an exemplary embodiment, the coatings are configured to facilitate temperature control within the second chamber 106 (e.g., the second cavity 162).

In an exemplary embodiment, one or more of the panels 170-176 include handles, for example, to facilitate gripping and/or engaging the panels 170-176. For example, as shown in FIGS. 1-2 the front panel 170 includes one or more handles 180, for example, to allow a user to engage the front panel 170 and/or manipulate the front panel 170 relative to the front wall 150 (e.g., remove the front panel 170 for cleaning, replacement, etc.). The first rear panel 172 and/or the second rear panel 173 may include one or more handles, shown as handles 182. The handles 182 may also allow a user to engage the first rear panel 172 and/or the second rear panel 173, for example, to move the first rear panel 172 relative to the second rear panel 173 to expose an interior of the second chamber 106 (e.g., the second cavity 162). As such, in an exemplary embodiment one or more of the panels 170-176 are coupled with the walls 150-160 via tracks and/or other movable components (e.g., wheels, rollers, pivot joints, hinges, etc.), such that the panels 170-176 are movable relative to the walls 150-160 and/or other components of the second chamber 106. In some embodiment, the panels 170-176 are coupled with the walls 150-160 via another suitable coupling component (e.g., an adhesive, a bolt or rod, welded or fastened, etc.).

Referring generally to FIGS. 5-9, the food service system 100 is shown to include a heating system 200 including one or more heating elements. In an exemplary embodiment, the first chamber 104 includes a first heating element or overhead heating element, shown as a first heating element 202, and a second heating element or shelf heating element, shown as a second heating element 204. According to an exemplary embodiment, the first heating element 202 and/or the second heating element 204 is/are configured to provide temperature control (e.g., heat, etc.) to the first chamber 104 (e.g., the first cavity 122).

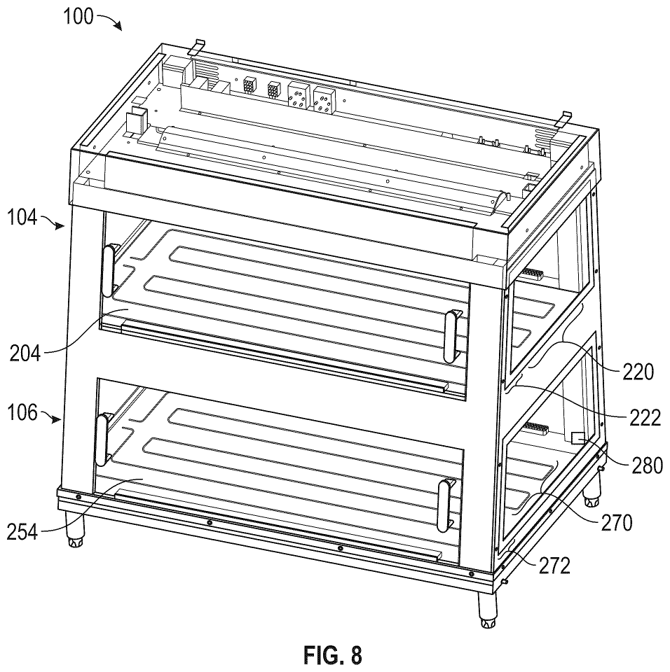

As shown in FIGS. 5-7, the first heating element 202 is positioned at a top portion of the first chamber 104. In an exemplary embodiment, the first heating element 202 is recessed within the top wall 118, for example within a cavity having a reflector 210. As shown in FIG. 7, the first heating element 202 is positioned at a central portion of the cavity (e.g., the reflector 210), and the reflector 210 has a semi-circular cross-sectional shape (e.g., a side cross-sectional shape), for example, to emit and/or deflect heat uniformly within the first chamber 104 (e.g., the first cavity 122). In an exemplary embodiment, the configuration of the first heating element 202 and/or the reflector 210 is/are configured to provide a food product with one or more predetermined characteristics within the first chamber 104 (e.g., a crispy or crunchy exterior, etc.). In some embodiments, the position and/or configuration of the first heating element 202 and/or the reflector 210 is dependent on the size and/or configuration of one or more components of the first chamber 104 (e.g., a height of the first side wall 114 and/or the second side wall 116, a depth of the top wall 118 and/or the bottom wall 120, etc.). For example, the first heating element 202 and/or the reflector 210 may be configured (e.g., positioned and/or oriented relative to the top wall 118) so as to emit and/or deflect heat to a predetermined portion of the first chamber 104 (e.g., a front portion of the first chamber 104, an edge adjacent the front wall 110 of the first chamber 104, etc.). In some embodiments, the reflector 210 is biased relative to the first chamber 104, for example to emit and/or deflect disproportionate heat within the first chamber 104. For example, the reflector 210 may be biased toward a rear portion of the first chamber 104 (e.g., toward the rear wall 112), for example to emit and/or deflect heat toward a rear portion of the first chamber 104.

According to an exemplary embodiment, the first heating element 202 is a calrod heating element and the reflector 210 is a stainless-steel reflector. The first heating element 202 is shown to span a distance within the first chamber 104 (e.g., substantially a distance of the top wall 118, etc.). For example, the first heating element 202 may span from approximately a first side of the first chamber 104 (e.g., the first side wall 114) to approximately a second side of the first chamber 104 (e.g., the second side wall 116). Further, the first heating element 202 may be positioned at a central portion of the first chamber 104. For example, the first heating element 202 may be positioned between a front portion of the first chamber 104 (e.g., the front wall 110) and a rear portion of the first chamber 104 (e.g., the rear wall 112). In an exemplary embodiment, the first heating element 202 is positioned equidistant between the front wall 110 and the rear wall 112. In other embodiments, the first heating element 202 and/or the reflector 210 are formed of other suitable material, have other suitable configurations, and/or are otherwise positioned or oriented.

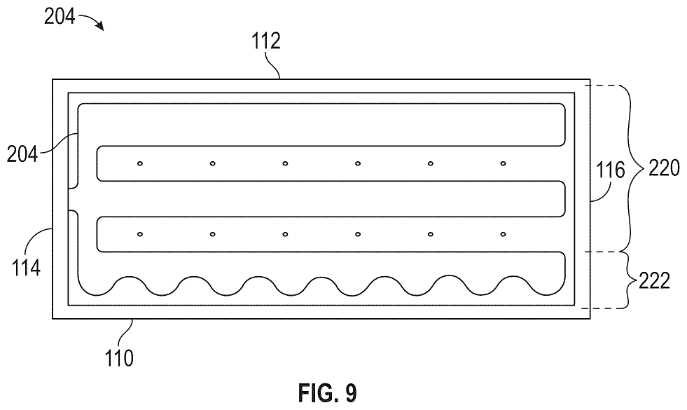

Referring now to FIGS. 8-9, the second heating element 204 is shown positioned at a bottom portion of the first chamber 104. In an exemplary embodiment, the second heating element 204 is mounted to the bottom wall 120 of the first chamber 104. In some embodiments, the second heating element 204 is an internal heating element, for example, mounted to within the bottom wall 120 (e.g., a foil heating element mounted within the bottom wall 120, applied to a heat sink, etc.). The second heating element 204 is shown to span a distance within the first chamber 104 (e.g., substantially a distance of the bottom wall 120). For example, the second heating element 204 may span from approximately a first side of the first chamber 104 (e.g., the first side wall 114) to approximately a second side of the first chamber 104 (e.g., the second side wall 116). Further, the second heating element 204 may span from approximately a third side of the first chamber 104 (e.g., the front wall 110) to approximately a fourth side of the first chamber 104 (e.g., the rear wall 112).

As shown in FIG. 9, the second heating element 204 is configured to emit and/or deflect heat in one or more heating patterns. For example, the second heating element 204 may include a first portion 220 that emits heat in a first heating pattern, and a second portion 222 that emits heat in a second heating pattern. In an exemplary embodiment, the first portion 220 is configured to emit heat in a pattern that is different (e.g., less heat density, more heat density, etc.) than the second portion 222. For example, the first portion 220 may be positioned at a rear portion of the first chamber 104 (e.g., toward the rear wall 112) and the second portion 222 may be positioned at a front portion of the first chamber 104 (e.g., toward the front wall 110), and the second portion 222 may be configured to emit heat at a higher density compared to the first portion 220, such that a front portion of the first chamber 104 provides a greater heat density. As shown in FIG. 9, in an exemplary embodiment the second heating element 204 includes heating components that are arranged in one or more configurations (e.g., serpentine, cross-hatched, parallel, perpendicular, etc. configurations). For example, the first portion 220 may include heating components arranged in a first serpentine configuration and the second portion 222 may include heating components arranged in a second serpentine configuration, where the configurations are different between the first portion 220 and the second portion 222 (e.g., the serpentine arrangement has a different frequency such as being more/less dense or compact in the second portion 222, has a different direction, has a different amplitude, etc.). For example, in some embodiments the number of serpentine curls or turns in the second portion 222 is proportionate to the number of serpentine curls or turns in the first portion 220 (e.g., 2:1, 3:1, 4:1, 5:1, etc.). In other embodiments, the components of the second heating element 204 are otherwise arranged and/or configured (e.g., parallel, cross-hatched, perpendicular, circular, checkerboard, chevron, diamond, grid, grid points, halftone, halftone grid, herringbone, weave, hexagon, and/or any other suitable patterns or configurations).

Referring back to FIG. 7, according to an exemplary embodiment the first chamber 104 includes a sensor (e.g., a temperature sensor, etc.), shown as a sensor 230. As shown, the sensor 230 may be positioned at a top portion of the first chamber 104; however, in other embodiments, the sensor 230 is otherwise positioned and/or oriented within the first chamber 104 (e.g., a bottom portion, a lateral side portion, a rear portion, a front portion, etc. of the first chamber 104). According to an exemplary embodiment, the sensor 230 is configured to detect a characteristic within the first chamber 104. For example, the sensor 230 may be a temperature sensor configured to determine a temperature within the first chamber 104. In other embodiments, the sensor 230 is another suitable sensor (e.g., a moisture sensor, a light sensor, etc.), for example to detect one or more characteristics (e.g., a moisture level, a light level, etc.) within the first chamber 104. In an exemplary embodiment, the sensor 230 is coupled with one or more components of the food service system 100 (e.g., the control panel 108, one or more controls, components of the heating system 200, components of an exhaust system, components of a lighting system, etc.), for example to facilitate control of one or more characteristics of the first chamber 104. In some embodiments, the first chamber 104 includes a plurality of sensors 230 (e.g., two, three, four, etc.), which may be positioned and/or oriented in any suitable configuration (e.g., at a top portion, bottom portion, central portion, lateral portion, front portion, rear portion, etc.), as described herein.

Referring still to FIGS. 5-9, the second chamber 106 may also include a first heating element or overhead heating element, shown as a first heating element 252, and a second heating element or shelf heating element, shown as a second heating element 254. According to an exemplary embodiment, the first heating element 252 and/or the second heating element 254 is/are configured to provide temperature control (e.g., heat, etc.) to the second chamber 106 (e.g., the second cavity 162). In an exemplary embodiment, the heating elements 202-204 of the first chamber 104 and the heating elements 252-254 of the second chamber 106 are configured to be controlled and/or operated by one or more components of the food service system 100 (e.g., via the control panel 108). In some embodiments, the heating elements 202-204 and/or the heating elements 252-254 are independently controllable. In some embodiments, the heating elements 202-204 and/or the heating elements 252-254 are controlled in groups (e.g., in pairs, via location, via temperature data, etc.), automatically controlled (e.g., via a feedback system, etc.), are remotely controlled (e.g., via control commands, etc.), and/or are controlled or operated via another suitable control mechanism.

As shown in FIG. 5, the first heating element 252 is positioned at a top portion of the second chamber 106. In an exemplary embodiment, the first heating element 252 is recessed within the top wall 158, for example, within a cavity having a reflector 260. The first heating element 252 may be positioned at a central portion of the cavity (e.g., the reflector 260), and the reflector 260 may have a semi-circular cross-sectional shape (e.g., a side cross-sectional shape), for example, to emit and/or deflect heat uniformly within the second chamber 106 (e.g., the second cavity 162). In an exemplary embodiment, the configuration of the first heating element 252 and/or the reflector 260 is/are configured to provide a food product with one or more predetermined characteristics within the second chamber 106 (e.g., a crispy or crunchy exterior, etc.). In some embodiments, the position and/or configuration of the first heating element 252 and/or the reflector 260 is dependent on the size and/or configuration of one or more components of the second chamber 106 (e.g., a height of the first side wall 154 and/or the second side wall 156, a depth of the top wall 158 and/or the bottom wall 160, etc.). For example, the first heating element 252 and/or the reflector 260 may be configured (e.g., positioned and/or oriented relative to the top wall 158) so as to emit and/or deflect heat to a predetermined portion of the second chamber 106 (e.g., a front portion of the second chamber 106, an edge adjacent the front wall 150 of the second chamber 106, etc.). In some embodiments, the reflector 260 is biased relative to the second chamber 106, for example to emit and/or deflect disproportionate heat within the second chamber 106. For example, the reflector 260 may be biased toward a rear portion of the second chamber 106 (e.g., toward the rear wall 152), for example to emit and/or deflect heat toward a rear portion of the second chamber 106.

According to an exemplary embodiment, the first heating element 252 is a calrod heating element and the reflector 260 is a stainless-steel reflector. The first heating element 252 may span a distance within the second chamber 106 (e.g., substantially a distance of the top wall 158, etc.). For example, the first heating element 252 may span from approximately a first side of the second chamber 106 (e.g., the first side wall 154) to approximately a second side of the second chamber 106 (e.g., the second side wall 156). Further, the first heating element 252 may be positioned at a central portion of the second chamber 106. For example, the first heating element 252 may be positioned between a front portion of the second chamber 106 (e.g., the front wall 150) and a rear portion of the second chamber 106 (e.g., the rear wall 152). In an exemplary embodiment, the first heating element 252 is positioned equidistant between the front wall 150 and the rear wall 152. In other embodiments, the first heating element 252 and/or the reflector 260 are formed of other suitable material, have other suitable configurations, and/or are otherwise positioned or oriented.

In some embodiments, the first heating element 202 of the first chamber 104 and the first heating element 252 of the second chamber 106 are positioned and/or oriented relative to one another. In an exemplary embodiment, the first heating element 202 of the first chamber 104 and the first heating element 252 of the second chamber 106 are offset from one another. For example, the first heating element 202 of the first chamber 104 and the first heating element 252 of the second chamber 106 may be offset from one another relative to a vertical axis of the body 102 (e.g., a vertical axis at a center point of the top wall 158, offset relative to a front portion of the body 102 and a rear portion of the body 102, etc.), as shown in at least FIG. 5. In some embodiments, the first heating element 202 of the first chamber 104 and the first heating element 252 of the second chamber 106 are aligned relative to one another (e.g., aligned along a vertical axis defined by the body 102, aligned laterally across the body 102, etc.). In some embodiments, the first heating element 202 and the first heating element 252 are otherwise arranged and/or positioned relative to one another.

Referring now to FIG. 8, the second heating element 254 is shown positioned at a bottom portion of the second chamber 106. In an exemplary embodiment, the second heating element 254 is mounted to the bottom wall 160 of the second chamber 106. In some embodiments, the second heating element 254 is an internal heating element, for example, mounted to within the bottom wall 160 (e.g., a foil heating element mounted within the bottom wall 160, applied to a heat sink, etc.). The second heating element 254 is shown to span a distance within the second chamber 106 (e.g., substantially a distance of the bottom wall 160). For example, the second heating element 254 may span from approximately a first side of the second chamber 106 (e.g., the first side wall 154) to approximately a second side of the second chamber 106 (e.g., the second side wall 156). Further, the second heating element 254 may span from approximately a third side of the second chamber 106 (e.g., the front wall 150) to approximately a fourth side of the second chamber 106 (e.g., the rear wall 152).

As described herein, the second heating element 254 may be configured to emit and/or deflect heat in one or more heating patterns. For example, the second heating element 254 may include a first portion 270 that emits heat in a first heating pattern, and a second portion 262 that emits heat in a second heating pattern. In an exemplary embodiment, the first portion 270 is configured to emit heat in a pattern that is different (e.g., less heat density, more heat density, etc.) than the second portion 272. For example, the first portion 270 may be positioned at a rear portion of the second chamber 106 (e.g., toward the rear wall 152) and the second portion 272 may be positioned at a front portion of the second chamber 106 (e.g., toward the front wall 150), and the second portion 272 may be configured to emit heat at a higher density compared to the first portion 270, such that a front portion of the second chamber 106 provides a greater heat density. As shown in FIG. 8, in an exemplary embodiment the second heating element 254 includes heating components that are arranged in one or more configurations (e.g., serpentine, cross-hatched, parallel, perpendicular, etc. configurations). For example, the first portion 270 may include heating components arranged in a first serpentine configuration and the second portion 272 may include heating components arranged in a second serpentine configuration, where the configurations are different between the first portion 270 and the second portion 272 (e.g., the serpentine arrangement is denser or compact in the second portion 272, etc.). In other embodiments, the components of the second heating element 254 are otherwise arranged and/or configured (e.g., parallel, cross-hatched, perpendicular, circular, checkerboard, chevron, diamond, grid, grid points, halftone, halftone grid, herringbone, weave, hexagon, and/or any other suitable patterns or configurations).

In some embodiments, the second heating element 204 of the first chamber 104 and the second heating element 254 of the second chamber 106 are positioned, oriented, and/or configured relative to one another. For example, as shown in FIG. 8 the second heating element 204 of the first chamber 104 and the second heating element 254 of the second chamber 106 may have similar orientations and configurations (e.g., first portions 220, 270 and second portions 222, 272 having different serpentine configurations, etc.). In some embodiments, the second heating element 204 of the first chamber 104 and the second heating element 254 of the second chamber 106 may have different orientations and/or configurations. For example, the second portion 262 of the second chamber 106 may have heating components that are more densely arranged (e.g., a serpentine pattern that is denser or more closely aligned, etc.) compared to the second portion 222 of the first chamber 104. In other embodiments, the second heating element 204 and the second heating element 254 are otherwise arranged, positioned, configured, and/or oriented relative to one another.

According to an exemplary embodiment, the second chamber 106 includes a sensor (e.g., a temperature sensor, etc.), shown as a sensor 280. In some embodiments, the food service system 100 includes a single sensor (e.g., the sensor 230, the sensor 280, etc.). The sensor 280 may be configured to detect a characteristic within the second chamber 106. For example, the sensor 280 may be a temperature sensor configured to determine a temperature within the second chamber 106. In other embodiments, the sensor 280 is another suitable sensor (e.g., a moisture sensor, a light sensor, etc.), for example to detect one or more characteristics (e.g., a moisture level, a light level, etc.) within the second chamber 106. The sensor 280 may be positioned at a bottom portion of the second chamber 106 (e.g., as shown in at least FIG. 8); however, in other embodiments, the sensor 280 is otherwise positioned and/or oriented within the second chamber 106 (e.g., a top portion, a lateral side portion, a rear portion, a front portion, etc. of the second chamber 106). In some embodiments the sensor 230 and the sensor 280 are similar sensors (e.g., temperature sensors, moisture sensors, light sensors, etc.); however, in other embodiments the sensor 230 and the sensor 280 are different sensors. In an exemplary embodiment, the sensor 280 is coupled with one or more components of the food service system 100 (e.g., the control panel 108, one or more controls, components of the heating system 200, components of an exhaust system, components of a lighting system, etc.), for example to facilitate control of one or more characteristics of the second chamber 106. In some embodiments, the second chamber 106 includes a plurality of sensors 280 (e.g., two, three, four, etc.), which may be positioned and/or oriented in any suitable configuration (e.g., at a top portion, bottom portion, central portion, lateral portion, front portion, rear portion, etc.), as described herein.

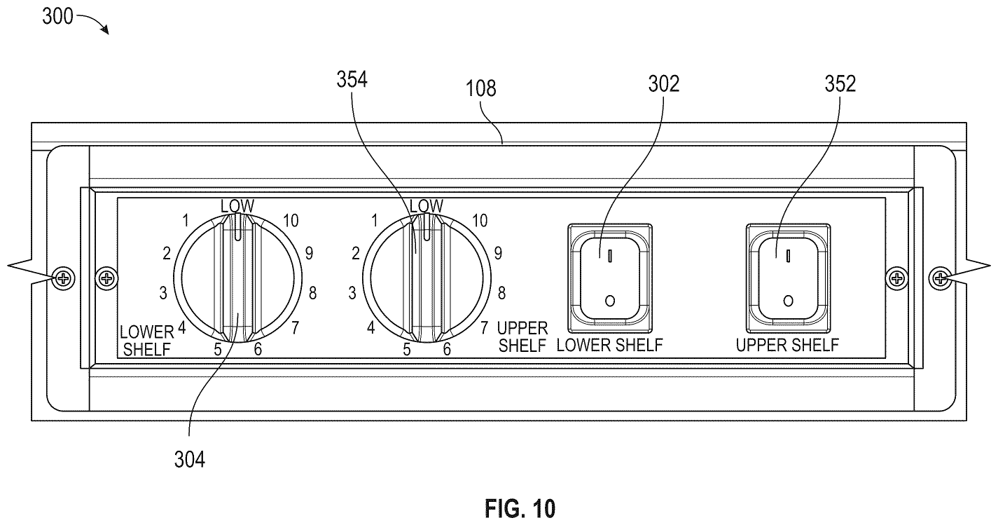

Referring now to FIG. 10, a control system 300 is shown, according to an exemplary embodiment. In an exemplary embodiment, the control system 300 is or includes the control panel 108 of FIG. 4. In an exemplary embodiment, the control panel 108 is configured to control one or more components of the food service system 100. For example, the control panel 108 (e.g., the control system 300) may be configured to control one or more components of a heating system (e.g., the heating system 200, etc.), an exhaust system, and/or a lighting system, as described herein.

According to an exemplary embodiment, the control panel 108 includes a first toggle 302. The first toggle 302 may be configured to control operation (e.g., power supply, on/off status, etc.) of one or more components of the first chamber 104. For example, the first toggle 302 may be configured to control operation of the first heating element 202 of the first chamber 104. In an exemplary embodiment, power to the first heating element 202 is controlled via the first toggle 302. Once power is supplied to the first heating element 202 (e.g., via the first toggle 302), the first heating element 202 may operate on a predetermined feedback-loop via data (e.g., temperature data, etc.) from the sensor 230. In this regard, in some embodiments the first heating element 202 is configured to operate via a feedback-loop, for example, in order to maintain a predetermined characteristic (e.g., predetermined temperature, humidity, moisture level, etc.) within the first chamber 104. In an exemplary embodiment, the first toggle 302 is also configured to control operation (e.g., power supply, power level, etc.) to one or more components of an exhaust system and/or a lighting system, as described herein. In other embodiments, the first toggle 302 is controllable (e.g., adjustable, controllable via one or more control commands, etc.), for example, to provide adjustable control of components of the first chamber 104.

According to an exemplary embodiment, the control panel 108 also includes a first dial 304. The first dial 304 may also be configured to control operation (e.g., power supply, on/off status, etc.) of one or more components of the first chamber 104. For example, the first dial 304 may be configured to control operation of the second heating element 204 of the first chamber 104. In an exemplary embodiment, the first dial 304 is configured to control a characteristic (e.g., temperature, level of heat emitted, pattern of heat emitted, etc.) of operation of the second heating element 204. The first dial 304 may be configured to be controlled via user and/or operator manipulation, or via automated controls (e.g., via data from the sensor 230, via one or more control commands, etc.). In some embodiments, operation of the first dial 304 is dependent on a status of the first toggle 302. For example, the first dial 304 may be inoperable (e.g., non-adjustable, in an off status, not powered, etc.) when the first toggle 302 is in a non-operating state (e.g., powered off, not powered on, etc.).

Referring still to FIG. 10, the control panel 108 is shown to also include a second toggle 352. The second toggle 352 may be configured to control operation (e.g., power supply, on/off status, etc.) of one or more components of the second chamber 106. For example, the second toggle 352 may be configured to control operation of the first heating element 252 of the second chamber 106. In an exemplary embodiment, power to the first heating element 252 is controlled via the second toggle 352. Once power is supplied to the first heating element 252 (e.g., via the second toggle 352), the first heating element 252 may operate on a predetermined feedback-loop via data (e.g., temperature data, etc.), for example, from a sensor (e.g., the sensor 280, the sensor 230, etc.). In this regard, in some embodiments the first heating element 252 is configured to operate via a feedback-loop, for example, to maintain a predetermined characteristic (e.g., predetermined temperature, humidity, moisture level, etc.) within the second chamber 106. In some embodiments, the second toggle 352 is configured to control operation (e.g., power supply, power level, etc.) to one or more components of an exhaust system and/or a lighting system, as described herein. In other embodiments, the second toggle 352 is controllable (e.g., adjustable, controllable via one or more control commands, etc.), for example, to provide adjustable control of components of the second chamber 106.

According to an exemplary embodiment, the control panel 108 also includes a second dial 354. The second dial 354 may also be configured to control operation (e.g., power supply, on/off status, etc.) of one or more components of the second chamber 106. For example, the second dial 354 may be configured to control operation of the second heating element 254 of the second chamber 106. In an exemplary embodiment, the second dial 354 is configured to control a characteristic (e.g., temperature, level of heat emitted, pattern of heat emitted, etc.) of operation of the second heating element 254. The second dial 354 may be configured to be controlled via user and/or operator manipulation, or via automated controls (e.g., via data from the sensor 280, the sensor 230, via one or more control commands, etc.). In some embodiments, operation of the second dial 354 is dependent on a status of the second toggle 352. For example, the second dial 354 may be inoperable (e.g., non-adjustable, in an off status, not powered, etc.) when the second toggle 352 is in a non-operating state (e.g., powered off, not powered on, etc.).

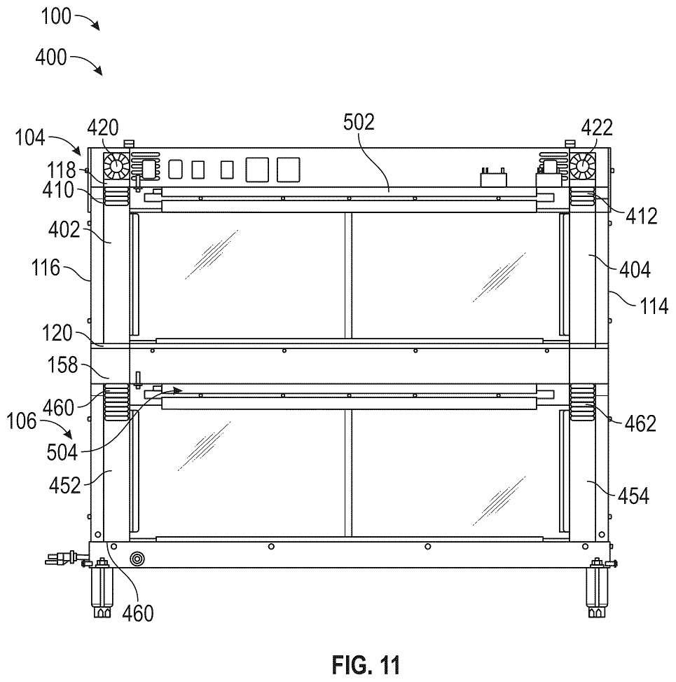

Referring now to FIGS. 11-13, the food service system 100 is shown to include an exhaust system 400. The exhaust system 400 may include one or more passages, ducts, channels, chambers, or passageways. Further, the exhaust system 400 may include one or more motors, fans, drums, or blowers. According to an exemplary embodiment, the exhaust system 400 is configured to control movement of air within the food service system 100 (e.g., draw air from, expel air from, exhaust air from, etc.). In this regard, the exhaust system 400 may be configured to provide air quality control (e.g., temperature control, moisture or humidity control, expel hot air, remove moisture or moist air, etc.) to the food service system 100 (e.g., the first chamber 104, the second chamber 106, etc.).

In an exemplary embodiment, the exhaust system 400 includes one or more channels and/or one or more fans. As shown in FIG. 11, the first chamber 104 includes a first passage or channel, shown as a first channel 402, and a first blower or fan, shown as a first fan 420. The first chamber 104 is also shown to include a second passage or channel, shown as a second channel 404, and a second blower or fan, shown as a second fan 422. According to an exemplary embodiment, the channels 402-404 and/or the fans 420-422 are configured to provide air quality control (e.g., temperature, humidity, moisture, etc. control) to the food service system 100 (e.g., the first chamber 104, etc.) by, for example, controlling movement of air within the food service system 100 (e.g., the first chamber 104, etc.).

As shown in FIG. 11, the first channel 402 extends within the first chamber 104. For example, the first channel 402 may extend from a top portion of the first chamber 104 (e.g., from the top wall 118) to a bottom portion of the first chamber 104 (e.g., to the bottom wall 120). In an exemplary embodiment, the first channel 402 is in communication with (e.g., coupled with, connected to, etc.) one or more openings (e.g., one or more openings in the first chamber 104, etc.). For example, the first channel 402 may be in communication with an opening at a top portion of the first chamber 104 (e.g., an opening in the top wall 118) and an opening at a bottom portion of the first chamber 104 (e.g., an opening in the bottom wall 120), for example, to form a passage or channel in the first chamber 104. In some embodiments, the first channel 402 couples with other openings in the first chamber 104 (e.g., an opening in the rear wall 112, an opening in a side wall, an opening in the bottom wall 120, etc.), for example, to form a passage or channel through the first chamber 104. In other embodiments, the first channel 402 extends within and/or through the first chamber 104 in another suitable configuration and/or orientation.

In an exemplary embodiment, the first channel 402 is positioned at a rear and/or exterior portion of the first chamber 104. For example, the first channel 402 may be positioned adjacent the rear wall 112 of the first chamber 104 and/or an exterior or side wall (e.g., the second side wall 116, etc.) of the first chamber 104. In this regard, and as shown in FIG. 11, the first channel 402 may be positioned at a rear-exterior corner of the first chamber 104 (e.g., adjacent the rear wall 112, the second side wall 116, etc.) and/or extend through the first chamber 104 (e.g., from the top wall 118 to the bottom wall 120, etc.), for example, to form a passage in the first chamber 104. In other embodiments, the first channel 402 is positioned at another suitable portion of the first chamber 104 (e.g., a rear/middle portion, an exterior/middle portion, a front/exterior portion, etc.).

In an exemplary embodiment, the first channel 402 includes one or more apertures, openings, gaps, vents, and/or other suitable holes. As shown in FIG. 11, the first channel 402 includes a plurality of vents 410. The vents 410 may be positioned at an end of the first channel 402, for example, to facilitate movement of air or other particles from an exterior of the first channel 402 to an interior of the first channel 402. In an exemplary embodiment, the vents 410 are positioned at an end of the first channel 402 at a top portion of the first chamber 104 (e.g., at the top wall 118, etc.). According to an exemplary embodiment, the number and/or size of the vents 410 is/are configured to allow a predetermined amount of air and/or particles to move through the vents 410 (e.g., from an exterior of the first channel 402 to an interior of the first channel 402, etc.). In some embodiments, the vents 410 are otherwise positioned at/on the first channel 402 (e.g., a middle portion, a side surface or portion, a bottom or lower portion, etc.).

As shown in FIG. 11, the first channel 402 is in communication with the first fan 420. The first channel 402 may be in communication with (e.g., coupled with, connected to, etc.) the first fan 420 at a first end of the first channel 402. For example, the first channel 402 may be coupled with the first fan 420 at an end of the first channel 402 at a top portion of the first chamber 104 (e.g., at the top wall 118, etc.). The first fan 420 may be positioned at a top portion of the first chamber 104, and/or may be in communication with an interior of the first chamber 104 and an exterior of the first chamber 104. Further, the first fan 420 may be in communication with one or more components of the control system 300 (e.g., the first toggle 302, the first dial 304, etc.), for example, to facilitate control of one or more operating parameters (e.g., power supply, on/off status, operating speed or conditions, etc.) of the first fan 420.

In an exemplary embodiment, the first fan 420 is configured to facilitate movement of air or other particles through the first channel 402. For example, to adjust the humidity, temperature, moisture, etc. of the air within the chambers based on sensor readings and control set points, the first fan 420 may be configured to draw air (e.g., hot air, moist air, etc.) through the first channel 402 (e.g., through the vents 410, etc.), thereby moving air from an interior of the first chamber 104 to an exterior of the first chamber 104. In this regard, the first fan 420 may be configured to draw a predetermined amount of air from an interior of the first chamber 104 (e.g., through the vents 410, through the first channel 402, etc.) and expel the air to an exterior of the first chamber 104, thereby providing air quality control (e.g., temperature, moisture, humidity, etc.) control to the first chamber 104.

Referring still to FIG. 11, the second channel 404 extends within the first chamber 104. For example, the second channel 404 may extend from a top portion of the first chamber 104 (e.g., from the top wall 118) to a bottom portion of the first chamber 104 (e.g., to the bottom wall 120). In an exemplary embodiment, the second channel 404 is in communication with (e.g., coupled with, connected to, etc.) one or more openings (e.g., one or more openings in the first chamber 104, etc.). For example, the second channel 404 may be in communication with an opening at a top portion of the first chamber 104 (e.g., an opening in the top wall 118) and an opening at a bottom portion of the first chamber 104 (e.g., an opening in the bottom wall 120), for example, to form a passage or channel in the first chamber 104. In some embodiments, the second channel 404 couples with other openings in the first chamber 104 (e.g., an opening in the rear wall 112, an opening in a side wall, an opening in the bottom wall 120, etc.), for example, to form a passage or channel through the first chamber 104. In other embodiments, the second channel 404 extends within and/or through the first chamber 104 in another suitable configuration and/or orientation.

In an exemplary embodiment, the second channel 404 is positioned at a rear and/or exterior portion of the first chamber 104. For example, the second channel 404 may be positioned adjacent the rear wall 112 of the first chamber 104 and/or an exterior or side wall (e.g., the first side wall 114, etc.) of the first chamber 104. In this regard, and as shown in FIG. 11, the second channel 404 may be positioned at a rear-exterior corner of the first chamber 104 (e.g., adjacent the rear wall 112, the second side wall 116, etc.) and/or extend through the first chamber 104 (e.g., from the top wall 118 to the bottom wall 120, etc.), for example, to form a passage in the first chamber 104. In an exemplary embodiment, the second channel 404 is positioned at an opposing portion of the first chamber 104 relative to the first channel 402. For example, and as shown in FIG. 11, the first channel 402 is positioned at a first exterior or side portion of the first chamber 104 (e.g., at the second side wall 116, etc.) and the second channel 404 is positioned at a second exterior or side portion of the first chamber 104 (e.g., at the second side wall 116), opposing the first exterior or side portion. In some embodiments, the second channel 404 and the first channel 402 are positioned at similar portions of the first chamber 104. For example, the first channel 402 and the second channel 404 may be positioned at a rear portion (e.g., at the rear wall 112, etc.) of the first chamber 104. In other embodiments, the second channel 404 is positioned at another suitable portion of the first chamber 104 (e.g., a rear/middle portion, an exterior/middle portion, a front/exterior portion, etc.).

In an exemplary embodiment, the second channel 404 includes one or more apertures, openings, gaps, vents, and/or other suitable holes. As shown in FIG. 11, the second channel 404 includes a plurality of vents 412. The vents 412 may be positioned at an end of the second channel 404, for example, to facilitate movement of air or other particles from an exterior of the second channel 404 to an interior of the second channel 404. In an exemplary embodiment, the vents 412 are positioned at an end of the second channel 404 at a top portion of the first chamber 104 (e.g., at the top wall 118, etc.). According to an exemplary embodiment, the number and/or size of the vents 412 is/are configured to allow a predetermined amount of air and/or particles to move through the vents 412 (e.g., from an exterior of the second channel 404 to an interior of the second channel 404, etc.). In some embodiments, the vents 412 are otherwise positioned at/on the second channel 404 (e.g., a middle portion, a side surface or portion, a bottom or lower portion, etc.).

As shown in FIG. 11, the second channel 404 is in communication with the second fan 422. The second channel 404 may be in communication with (e.g., coupled with, connected to, etc.) the second fan 422 at a first end of the second channel 404. For example, the second channel 404 may be coupled with the second fan 422 at an end of the second channel 404 at a top portion of the first chamber 104 (e.g., at the top wall 118, etc.). The second fan 422 may be positioned at a top portion of the first chamber 104, and/or may be in communication with an interior of the first chamber 104 and an exterior of the first chamber 104. Further, the second fan 422 may be in communication with one or more components of the control system 300 (e.g., the second toggle 352, the second dial 354, etc.), for example to facilitate control of one or more operating parameters (e.g., power supply, on/off status, operating speed or conditions, etc.) of the second fan 422.

In an exemplary embodiment, the second fan 422 is configured to facilitate movement of air or other particles through the second channel 404. For example, the second fan 422 may be configured to draw air (e.g., hot air, moist air, etc.) through the second channel 404 (e.g., through the vents 412, etc.), thereby moving air from an interior of the first chamber 104 to an exterior of the first chamber 104. In this regard, the second fan 422 may be configured to draw a predetermined amount of air from an interior of the first chamber 104 (e.g., through the vents 412, through the second channel 404, etc.) and expel the air to an exterior of the first chamber 104, thereby providing air quality control (e.g., temperature, moisture, humidity, etc.) control to the first chamber 104.

Referring still to FIGS. 11-13, the second chamber 106 is also shown to include a first passage or channel, shown as a first channel 452 and a second passage or channel, shown as a second channel 454. Further, the first channel 452 and/or the second channel 454 is/are shown to include one or more apertures, openings, gaps, vents, and/or other suitable holes, shown as vents 460 and vents 462, respectively. As discussed above, in an exemplary embodiment the channels 452-454 are configured to provide air quality control (e.g., temperature, humidity, moisture, etc. control) to the food service system 100 (e.g., the first chamber 104, etc.) by, for example, controlling movement of air within the food service system 100 (e.g., the first chamber 104, etc.).

As shown in FIG. 11, the first channel 452 extends within the second chamber 106. For example, the first channel 452 may extend from a top portion of the second chamber 106 (e.g., from the top wall 158) to a bottom portion of the second chamber 106 (e.g., to the bottom wall 160). In an exemplary embodiment, the first channel 452 is in communication with (e.g., coupled with, connected to, etc.) one or more openings (e.g., one or more openings in the second chamber 106, etc.). For example, the first channel 452 may be in communication with an opening at a top portion of the second chamber 106 (e.g., an opening in the top wall 158), for example, to form a passage or channel in the second chamber 106. In an exemplary embodiment, the first channel 452 is in communication with the first channel 402 of the first chamber 104, for example, to form a passage or channel in the first chamber 104 and the second chamber 106. In some embodiments, the first channels 402, 452 are integrated as a single channel; however, in other embodiments the second channels 404, 454 are modular (e.g., separate, etc.) components. In other embodiments, the first channel 452 couples with other openings in the second chamber 106 (e.g., an opening in the rear wall 152, an opening in a side wall, an opening in the bottom wall 160, etc.), for example, to form a passage or channel through the second chamber 106. In other embodiments, the first channel 452 extends within and/or through the second chamber 106 in another suitable configuration and/or orientation.

In an exemplary embodiment, the first channel 452 is positioned at a rear and/or exterior portion of the second chamber 106. For example, the first channel 452 may be positioned adjacent the rear wall 152 of the second chamber 106 and/or an exterior or side wall (e.g., the second side wall 156, etc.) of the second chamber 106. In this regard, and as shown in FIG. 11, the first channel 452 may be positioned at a rear-exterior corner of the second chamber 106 (e.g., adjacent the rear wall 152, the second side wall 156, etc.) and/or extend through the second chamber 106 (e.g., from the top wall 158 to the bottom wall 160, etc.), for example, to form a passage in the second chamber 106. In other embodiments, the first channel 452 is positioned at another suitable portion of the second chamber 106 (e.g., a rear/middle portion, an exterior/middle portion, a front/exterior portion, etc.).

As shown in FIG. 11, the first channel 452 includes the vents 460. The vents 460 may be positioned at an end of the first channel 452, for example, to facilitate movement of air or other particles from an exterior of the first channel 452 to an interior of the first channel 452. In an exemplary embodiment, the vents 460 are positioned at an end of the first channel 452 at a top portion of the second chamber 106 (e.g., at the top wall 158, etc.). According to an exemplary embodiment, the number and/or size of the vents 460 is/are configured to allow a predetermined amount of air and/or particles to move through the vents 460 (e.g., from an exterior of the first channel 452 to an interior of the first channel 452, etc.). In some embodiments, the number and/or size of the vents 460 is/are proportional to the number and/or size of the vents 410 (e.g., 2:1, 3:1, 3:2, etc.). For example, in some embodiments the number and/or size of the vents 460 of the second chamber 106 is/are twice as large as the number and/or size of the vents 410 of the first chamber 104. In other embodiments, the vents 460 are otherwise positioned at/on the first channel 452 (e.g., a middle portion, a side surface or portion, a bottom or lower portion, etc.).

As discussed herein, in an exemplary embodiment the first channel 402 of the first chamber 104 is in communication with the first fan 420. The first channel 452 of the second chamber 106 may be in communication with (e.g., coupled with, connected to, etc.) the first channel 402 of the first chamber 104. In this regard, the first channel 452 of the second chamber 106 may also be in communication with the first fan 420. In other embodiments, the first channel 452 of the second chamber 106 is in communication with another fan (e.g., a third fan, a fourth fan, another fan separate from the first fan 420, etc.), which may be coupled with the first channel 452 and/or configured to facilitate movement of air or other particles relative to the second chamber 106.

In an exemplary embodiment, the first fan 420 is configured to facilitate movement of air or other particles through the first channel 452. For example, the first fan 420 may be configured to draw air or other particles (e.g., hot air, moist air, etc.) through the first channel 452 (e.g., through the vents 460, etc.), thereby moving air from an interior of the second chamber 106 to an exterior of the food service system 100 (e.g., through the first channel 452, the first channel 402, to an exterior of the first chamber 104, etc.). In this regard, the first fan 420 may be configured to draw a predetermined amount of air from an interior of the second chamber 106 (e.g., through the vents 460, through the first channel 452, etc.) and expel the air to an exterior of the food service system 100, thereby providing air quality control (e.g., temperature, moisture, humidity, etc.) control to the second chamber 106.

Referring still to FIG. 11, the second channel 454 also extends within the second chamber 106. For example, the second channel 454 may extend from a top portion of the second chamber 106 (e.g., from the top wall 158) to a bottom portion of the second chamber 106 (e.g., to the bottom wall 160). In an exemplary embodiment, the second channel 454 is in communication with (e.g., coupled with, connected to, etc.) one or more openings (e.g., one or more openings in the second chamber 106, etc.). For example, the second channel 454 may be in communication with an opening at a top portion of the second chamber 106 (e.g., an opening in the top wall 158), for example, to form a passage or channel in the second chamber 106. In an exemplary embodiment, the second channel 454 is in communication with the second channel 404 of the first chamber 104, for example, to form a passage or channel in the first chamber 104 and the second chamber 106. In some embodiments, the second channels 404, 454 are integrated as a single channel; however, in other embodiments the second channels 404, 454 are modular (e.g., separate, etc.) components. In some embodiments, the second channel 454 couples with other openings in the second chamber 106 (e.g., an opening in the rear wall 152, an opening in a side wall, an opening in the bottom wall 160, etc.), for example, to form a passage or channel through the second chamber 106. In other embodiments, the second channel 454 extends within and/or through the second chamber 106 in another suitable configuration and/or orientation.

In an exemplary embodiment, the second channel 454 is positioned at a rear and/or exterior portion of the second chamber 106. For example, the second channel 454 may be positioned adjacent the rear wall 152 of the second chamber 106 and/or an exterior or side wall (e.g., the first side wall 154, etc.) of the second chamber 106. In this regard, and as shown in FIG. 11, the second channel 454 may be positioned at a rear-exterior corner of the second chamber 106 (e.g., adjacent the rear wall 152, the second side wall 156, etc.) and/or extend through the second chamber 106 (e.g., from the top wall 158 to the bottom wall 160, etc.), for example, to form a passage in the second chamber 106. In an exemplary embodiment, the second channel 454 is positioned at an opposing portion of the second chamber 106 relative to the first channel 452. For example, and as shown in FIG. 11, the first channel 452 is positioned at a first exterior or side portion of the second chamber 106 (e.g., at the second side wall 156, etc.) and the second channel 454 is positioned at a second exterior or side portion of the second chamber 106 (e.g., at the second side wall 156), opposing the first exterior or side portion. In some embodiments, the second channel 454 and the first channel 452 are positioned at similar portions of the second chamber 106. For example, the first channel 452 and the second channel 454 may be positioned at a rear portion (e.g., at the rear wall 152, etc.) of the second chamber 106. In other embodiments, the second channel 454 is positioned at another suitable portion of the second chamber 106 (e.g., a rear/middle portion, an exterior/middle portion, a front/exterior portion, etc.).

As shown in FIG. 11, the second channel 454 includes the vents 462. The vents 462 may be positioned at an end of the second channel 454, for example, to facilitate movement of air or other particles from an exterior of the second channel 454 to an interior of the second channel 454. In an exemplary embodiment, the vents 462 are positioned at an end of the second channel 454 at a top portion of the second chamber 106 (e.g., at the top wall 158, etc.). According to an exemplary embodiment, the number and/or size of the vents 462 is/are configured to allow a predetermined amount of air and/or particles to move through the vents 462 (e.g., from an exterior of the second channel 454 to an interior of the second channel 454, etc.). In some embodiments, the vents 462 are otherwise positioned at/on the second channel 454 (e.g., a middle portion, a side surface or portion, a bottom or lower portion, etc.).

As discussed herein, in an exemplary embodiment the second channel 404 of the first chamber 104 is in communication with the second fan 422. The second channel 454 of the second chamber 106 may be in communication with (e.g., coupled with, connected to, etc.) the second channel 404 of the first chamber 104. In this regard, the second channel 454 of the second chamber 106 may also be in communication with the second fan 422. In other embodiments, the second channel 454 of the second chamber 106 is in communication with another fan (e.g., a third fan, a fourth fan, another fan separate from the second fan 422, etc.), which may be coupled with the second channel 454 and/or configured to facilitate movement of air or other particles relative to the second chamber 106.

In an exemplary embodiment, the second fan 422 is configured to facilitate movement of air or other particles through the second channel 454. For example, the second fan 422 may be configured to draw air or other particles (e.g., hot air, moist air, etc.) through the second channel 454 (e.g., through the vents 462, etc.), thereby moving air from an interior of the second chamber 106 to an exterior of the food service system 100 (e.g., through the second channel 454, the second channel 404, to an exterior of the first chamber 104, etc.). In this regard, the second fan 422 may be configured to draw a predetermined amount of air from an interior of the second chamber 106 (e.g., through the vents 462, through the second channel 454, etc.) and expel the air to an exterior of the food service system 100, thereby providing air quality control (e.g., temperature, moisture, humidity, etc.) control to the second chamber 106.

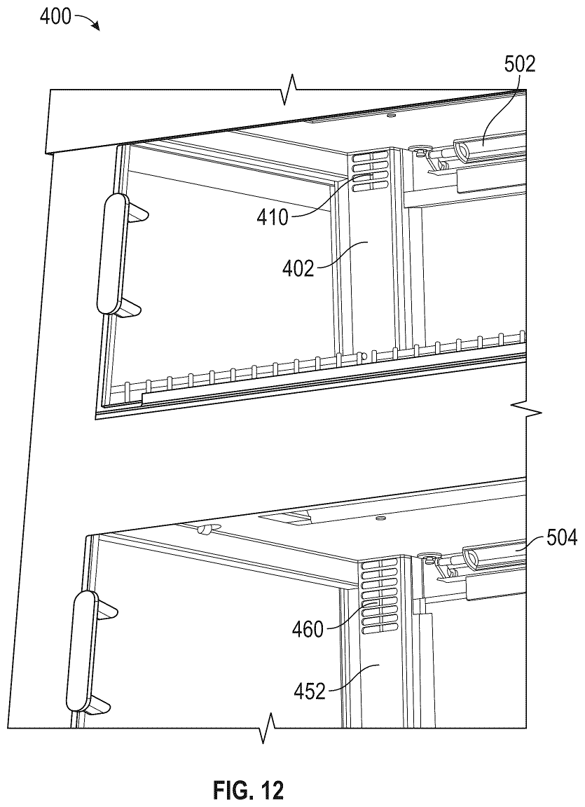

As shown in FIGS. 11-12, the food service system 100 also includes a lighting system 500. The lighting system 500 is shown to include one or more lighting elements. As shown in FIG. 11, the first chamber 104 includes a first lighting element or light fixture, shown as a light 502, and the second chamber 106 includes a second lighting element or light fixture, shown as a light 504. In an exemplary embodiment, the first chamber 104 includes a plurality of lights 502 (e.g., two, three, four, etc. lights) and the second chamber 106 includes a plurality of lights 504 (e.g., two, three, four, etc. lights). The light s502 may be coupled to a top portion of the first chamber 104 (e.g., the top wall 118 at front and rear portions, etc.), and may be configured to selectively provide light to the first chamber 104 and/or to facilitate viewing components within the first cavity 122 (e.g., bone-in chicken, etc.). Similarly, the light 504 may be coupled to a top portion of the second chamber 106 (e.g., the top wall 158 at front and rear portions, etc.), and may be configured to selectively provide light to the second chamber 106 and/or to facilitate viewing components within the second cavity 162 (e.g., chicken tenders, chicken sandwiches, etc.). The lights 502, 504 may be formed of light emitting diodes (“LEDs”), and/or may be in communication with one or more components of the control system 300 (e.g., the toggles 302, 352, the dials 304, 354, etc.), for example, to facilitate control of one or more operating parameters (e.g., power supply, on/off status, operating speed or conditions, etc.) of the lights 502, 504.

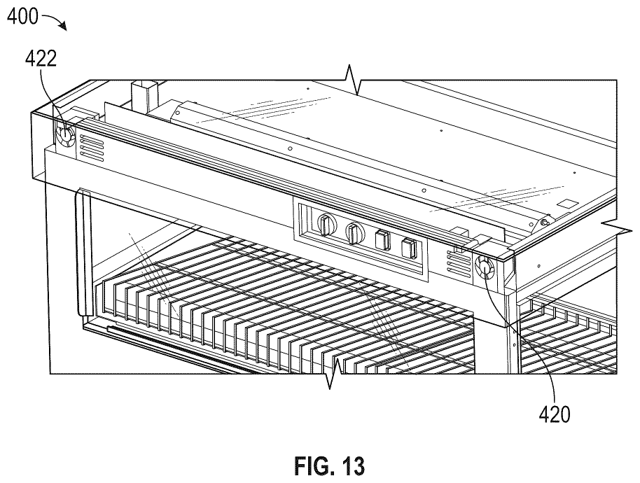

As shown in at least FIGS. 12-13, the food service system 100 also includes a service system 600. According to an exemplary embodiment, the service system 600 includes one or more components configured to facilitate serving and/or servicing a food product. For example, the service system 600 includes one or more racks, shown as first rack 602 and second rack 604. The racks 602, 604 may be positioned within the chambers (e.g., the first chamber 104, the second chamber 106, etc.), and may be configured to support a food product for display. Further, the service system 600 may include other service utensils (e.g., fork, spoon, knife, spatula, tongs, etc.), and/or display indicators (e.g., a name plate, price tag, food product description, etc.).

As an illustrative example, a user or operator may desire to maintain a food product having certain characteristics for a predetermined period of time. For example, a user or operator may desire to maintain bone-in chicken or chicken wings at a certain temperature (e.g., 135 degrees Fahrenheit), while maintaining a crispy or crunchy exterior and a moist interior, for a 4-hour time period. Further, a user or operator may also desire to maintain chicken tenders or chicken sandwiches at a certain temperature (e.g., 135 degrees Fahrenheit), while maintaining a crispy or crunchy exterior and a moist interior, for a 2-hour time period. In an exemplary embodiment, the food service system 100 of FIGS. 1-13 can be implemented to maintain the desired food products at desired characteristics for a desired period of time.

The food service system 100 of FIGS. 1-13 may be provided, and the toggle switches (e.g., the first toggle 302, the second toggle 352, etc.) may be turned on to power the food service system 100. With the toggle switches on, the overhead heating elements (e.g., the first heating element 202, the first heating element 252, etc.), the fans (e.g., the first fan 420, the second fan 422, etc.), and the lighting elements (e.g., lighting elements 502, 504, etc.) may be powered on. The overhead heading elements may provide a predetermined amount of heat (e.g., a set or scheduled amount of heat, etc.), which may be controlled by one or more sensors within the chambers (e.g., the sensor 230, the sensor 280, etc.). The sensors may provide feedback to a control system (e.g., the control system 300, etc.) and/or the overhead heating elements, for example to control an amount of heat emitted by the overhead heating elements to hold (e.g., set, establish, maintain, etc.) a temperature in the chambers (e.g., the first chamber 104, the second chamber 106, etc.). With the toggle switches on, the shelf heating elements (e.g., the second heating element 204, the second heating element 254, etc.) may be powered on and/or controlled, for example to provide controlled emission of heat from bottom portions of the chambers.

With the toggle switches turned on, and the overhead heating elements and the shelf heating elements providing heat to the chambers, the fans (e.g., the first fan 420, the second fan 422) can be powered on and/or drawn air from the chambers. For example, the fans can draw air (e.g., heated air, warm air, moist air, etc.) from an interior of the chambers (e.g., via the channels 402 and 454, the channels 404 and 454, etc.), and expel the air to an exterior of the food service system 100. As the air is drawn from an interior of the chambers and expelled to an exterior portion of the food service system 100, the air that remains in the chambers provides a certain level of air quality control (e.g., temperature control and/or maintenance, moisture or humidity control and/or maintenance), which facilitates maintaining the food products contained therein at a desired temperature and/or having desired characteristics (e.g., bone-in chicken having a crispy or crunchy exterior with a moist interior, etc.) for a desired amount of time (e.g., 4 hours).

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

As mentioned above and in one configuration, the “circuits” may be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

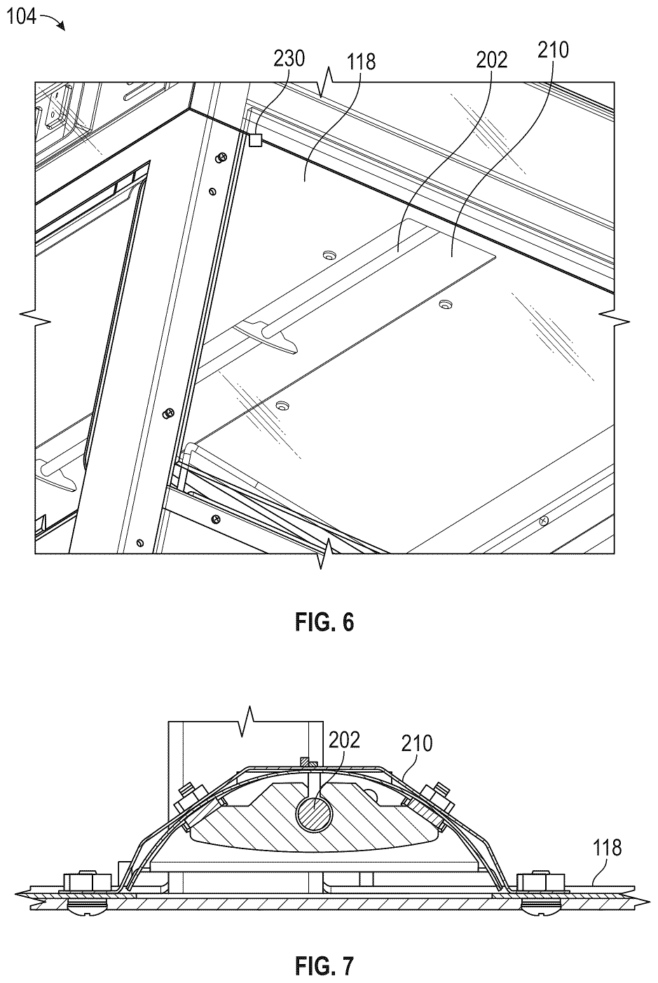

It is important to note that any element disclosed in one embodiment may be incorporated or utilized with any other embodiment disclosed herein. For example, the sensor 230 of the exemplary embodiment described in at least the corresponding description of FIG. 6 may be incorporated in the second chamber of the exemplary embodiment described in at least the corresponding description of FIGS. 1-5. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A food service system comprising:
a first chamber having one or more walls, the first chamber comprising:
a first heating element to selectively provide heat to the first chamber to heat a food product; and
a first channel extending within the first chamber, the first channel to facilitate movement of air within the first chamber;
a second chamber having one or more walls, the second chamber comprising:
a second channel in communication with the first channel, the second channel extending within the second chamber, wherein the second channel facilitates movement of air within the second chamber; and
a first fan coupled with the first channel, wherein the first fan draws air through the second channel and the first channel, and to an exterior of the first chamber to provide temperature control to the first chamber and the second chamber.

2. The food service system of claim 1, wherein the first channel includes a first plurality of vents to facilitate movement of air from the first chamber to the exterior of the first chamber, and the second channel includes a second plurality of vents to facilitate movement of air from the second chamber to the exterior of the first chamber.

3. The food service system of claim 2, wherein the first plurality of vents are positioned at an end of the first channel at a top wall of the first chamber, and the second plurality of vents are positioned at an end of the second channel at a top wall of the second chamber.

4. The food service system of claim 2, wherein the second plurality of vents includes more vents than the first plurality of vents.

5. The food service system of claim 1, wherein the first channel is positioned at a rear portion and a first exterior portion of the first chamber, and the second channel is positioned at a rear portion and a first exterior portion of the second chamber.

6. The food service system of claim 5, wherein:
the first chamber further comprises a third channel extending within the first chamber, the third channel to facilitate movement of air within the first chamber; and
the second chamber further comprises a fourth channel extending within the second chamber, wherein the fourth channel is in communication with the third channel, and the fourth channel facilitates movement of air within the second chamber.

7. The food service system of claim 6, further comprising:
a second fan coupled with the third channel, wherein the second fan draws air through the fourth channel and the third channel, and to an exterior of the first chamber to provide temperature control to the first chamber and the second chamber.

8. The food service system of claim 6, wherein:
the third channel is positioned at the rear portion of the first chamber, wherein the third channel is positioned at a second exterior portion opposite the first exterior portion of the first chamber; and
the fourth channel is positioned at the rear portion of the second chamber, wherein the fourth channel is positioned at a second exterior portion opposite the first exterior portion of the second chamber.

9. The food service system of claim 6, wherein the third channel includes a first plurality of vents positioned at an end of the third channel at a top wall of the first chamber, and the fourth channel includes a second plurality of vents positioned at an end of the fourth channel at a top wall of the second chamber.

10. The food service system of claim 1, further comprising a sensor to receive temperature data associated with a temperature of the first chamber and the second chamber,
wherein in response to the temperature data the first fan receives power to draw the air through the second channel and the first channel, and to an exterior of the first chamber.

11. The food service system of claim 1, wherein the first chamber includes a front wall having a front panel and a rear wall having a rear panel, wherein the rear panel is movable to selectively enclose the first chamber.

12. The food service system of claim 11, wherein the front panel and the rear panel are formed of tempered glass having a light emitting coating on a surface.

13. The food service system of claim 1, wherein the first heating element is positioned at a bottom wall of the first chamber, the first heating element including:
a first set of heating elements forming a first configuration to provide a first heating pattern; and
a second set of heating elements forming a second configuration to provide a second heating pattern.

14. The food service system of claim 13, wherein:
the first configuration is a first serpentine pattern and the second configuration is a second serpentine pattern; and
a first distance between curves in the first serpentine pattern is different than a second distance between curves in the second serpentine pattern.

15. The food service system of claim 13, wherein the first heating pattern emits more heat that the second heating pattern.

16. A food service system for a first food product and a second food product, the food service system comprising:
a housing;
a first chamber within the housing and having one or more walls, the first chamber comprising a first heating element to selectively provide heat to the first chamber to heat the first food product;
a second chamber within the housing and having one or more walls, the second chamber comprising a second heating element to selectively provide heat to the second chamber to heat the second food product;
a first channel in communication with the first chamber, the second chamber, and an exterior of the housing to facilitate movement of air between the first chamber, the second chamber, and the exterior; and
a first fan in communication with the first channel, wherein the first fan draws air from the first chamber and the second chamber and exhausts it to the exterior to provide temperature and humidity control to the first chamber and the second chamber.

17. The food service system of claim 16, wherein a second channel in communication with the first chamber, the second chamber, and an exterior of the housing to facilitate movement of air between the first chamber, the second chamber, and the exterior.

18. The food service system of claim 17, wherein the first channel includes a first vent defining a first aperture area in communication with the first chamber, and the second channel includes a second vent defining a second aperture area in communication with the second chamber, wherein the first aperture area is greater than the second aperture area.

19. A food service apparatus comprising:
a first chamber having one or more walls and a first heating element to selectively provide heat to the first chamber to heat a first food product;
a second chamber having one or more walls and a second heating element to selectively provide heat to the second chamber to heat a second food product;
a channel in communication with the first chamber, the second chamber, and an exterior of the first chamber and the second chamber to facilitate movement of air between the first chamber, the second chamber, and the exterior; and
a fan in communication with the channel, wherein the fan draws air from the first chamber and the second chamber and exhausts it to the exterior to provide temperature and humidity control to the first chamber and the second chamber.

20. The food service apparatus of claim 19, wherein the channel includes a first vent defining a first aperture area in communication with the first chamber, and a second vent defining a second aperture area in communication with the second chamber, wherein the first aperture area is greater than the second aperture area.
